(19) United States
(12) Patent Application Publication
(10) Pub. No.: US 2025/0391928 A1
(43) Pub. Date: Dec. 25, 2025

(54) ELECTROLYTE IN RECHARGEABLE BATTERY

(71) Applicant: HUNT ENERGY ENTERPRISES, L.L.C., Dallas, TX (US)

(72) Inventors: Vivek Dhas, Dallas, TX (US); Anthony Ruth, Dallas, TX (US); Fantai Kong, McKinney, TX (US)

(21) Appl. No.: 18/636,847

(22) Filed: Apr. 16, 2024

(51) Int. Cl. H01M 10/38; H01M 50/497

(52) U.S. Cl. CPC H01M 10/38; H01M 50/497; H01M 2300/0011

(57) ABSTRACT

Particular embodiments described herein provide for a battery that includes a zinc anode, a manganese cathode, and an electrolyte. The electrolyte includes an acetate and a sulfate. In some examples, the acetate to sulfate ratio is about 1:1.

### TECHNICAL FIELD

This disclosure relates in general to the field of energy storage devices, and more particularly, to an electrolyte in a rechargeable battery.

### BACKGROUND

A battery is a collection of one or more cells that store electrical energy and is capable of using the stored electrical energy to supply electric power. The cell is a basic electrochemical unit that handles the actual storage of the energy in the battery. The cell includes three main components; at least two electrodes and an electrolyte. The two electrodes are an anode, the negative electrode, and a cathode, the positive electrode.

When the anode loses electrons to an external circuit, the anode becomes oxidized. The anode can also be called the fuel electrode or the reducing electrode. Once the cathode accepts electrons from the internal circuit, the cathode gets reduced. The cathode can also be called the oxidizing electrode. The electrolyte acts as the medium for transferring charge in the form of ions between the two electrodes. Generally, the electrolyte is not electrically conductive but is Ionically conductive and is often referred to as an ionic conductor. The chemical reactions create the flow of electrons within a circuit. The stored chemical energy is then converted into direct current electric energy.

There are two main types of batteries, a primary battery and a secondary battery. Primary batteries cannot be recharged and are often a power source for portable electronics and devices. Primary batteries can only be used once and cannot be recharged. Most primary batteries are single cell batteries with one anode and one cathode. Secondary batteries can be recharged and are often used as energy storage devices. Secondary batteries can be a single cell battery with one anode and one cathode or a multiple cell battery with a plurality of anodes and cathodes.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a battery, in accordance with an embodiment of the present disclosure;

FIG. 2 is simplified table illustrating example details of initial concentrations of species in an electrolyte in battery, in accordance with an embodiment of the present disclosure;

FIG. 3 is a simplified table illustrating example details of reactions that may occur in battery, in accordance with an embodiment of the present disclosure;

FIG. 4 is a simplified graph illustrating example details of reactions that may occur in battery, in accordance with an embodiment of the present disclosure;

FIG. 5 is a simplified graph illustrating example details of reactions that may occur in battery, in accordance with an embodiment of the present disclosure;

FIG. 6 is a simplified graph illustrating example details of reactions that may occur in battery, in accordance with an embodiment of the present disclosure;

FIG. 7 is a simplified graph illustrating example details of the capacity of a battery with an electrolyte that includes a single buffer as compared to the capacity of a battery with an electrolyte that includes two buffers, in accordance with an embodiment of the present disclosure;

FIG. 8 is a simplified graph illustrating example details of the capacity of a battery with different electrolytes that produce a different pH, in accordance with an embodiment of the present disclosure;

FIG. 9 is a simplified graph illustrating example details related to the species on a cathode in a battery, in accordance with an embodiment of the present disclosure;

FIG. 10 is a simplified graph illustrating example details related to the species on a cathode in a battery with an electrolyte that includes a single buffer, in accordance with an embodiment of the present disclosure;

FIG. 11 is a simplified graph illustrating example details related to the species on a cathode in a battery with an electrolyte that includes two buffers, in accordance with an embodiment of the present disclosure;

FIG. 12 is a simplified graph illustrating example details of the capacity of a battery after undergoing cycling, in accordance with an embodiment of the present disclosure;

FIG. 13 is a simplified graph illustrating example details of the capacity of a battery after undergoing cycling and electrical conditioning of the battery, in accordance with an embodiment of the present disclosure;

FIG. 14 is a simplified graph illustrating example details of the capacity of a battery after undergoing cycling as compared to a battery after undergoing cycling and electrical conditioning of the battery, in accordance with an embodiment of the present disclosure;

FIG. 15 is a simplified block diagram illustrating example details of a battery with a proton exchange membrane as the separator, in accordance with an embodiment of the present disclosure;

FIG. 16 is a simplified block diagram illustrating example details of a battery with a proton exchange membrane as the separator, in accordance with an embodiment of the present disclosure;

FIG. 17 is a simplified block diagram illustrating example details of a battery with a proton exchange membrane as the separator, in accordance with an embodiment of the present disclosure; and

FIG. 18 is a simplified block diagram illustrating example details of a battery with a proton exchange membrane as the separator, in accordance with an embodiment of the present disclosure.

The FIGURES of the drawings are not necessarily drawn to scale, as their dimensions can be varied considerably without departing from the scope of the present disclosure.

### DETAILED DESCRIPTION

The following detailed description sets forth examples of apparatuses, methods, and systems relating to an electrolyte in a rechargeable battery in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

In an example, a battery can include an electrolyte, at least one anode, at least one cathode, and a separator. The anode includes an anode active material and the cathode includes a cathode active material. The anode active material can react with the electrolyte in the battery to produce electrons and the electrons can accumulate at the anode. The cathode active material can react with the electrolyte in the battery in a reaction that produces protons and helps to enable the cathode to accept or attract electrons. The battery can be a “sealed” or “closed” battery meaning that during charging and discharging, no new material is added to the battery and the battery does not circulate electrolyte (e.g., with a pump or other means) or have ports, inlets, conduits, etc. for the addition of material to the battery. A battery management system can control the cycling of the battery and testing of the battery's performance levels.

The active material in the anode and in the cathode varies depending on the battery type and some active materials perform best in alkaline conditions while other active materials perform best in acid conditions. For example, many oxides have a lot of metal atoms that are only stable in alkaline conditions. More specifically, manganese has many different oxides and they are only stable in alkaline conditions.

The electrolyte in the battery can be a mixture that allows for dissolution and deposition reactions during charging and discharging of the battery. In an example, the electrolyte controls the pH of the battery such that the during charging of the battery, the pH is acidic, in an acidic condition, and/or more acidic when compared to the pH when the battery is discharging, and when discharging the battery, the pH is alkaline, in an alkaline condition, and/or more alkaline when compared to the pH when the battery is charging. During discharge of the battery, the battery is in an alkaline condition and active material is oxidized and can become inert and not able to accept electrons. By moving the electrolyte in the battery from alkaline to acidic during recharging of the battery, the oxidized active material starts to dissolve, the active material ions can be redeposited on the electrode, the battery can be recharged, and the cycle can be repeated. More specifically, during discharge of the battery, the mixture of the electrolyte allows for protons to be consumed and raise the pH of the electrolyte to an alkaline condition and when charging the battery, the mixture of the electrolyte allows for the release of protons and the pH of the electrolyte moves down to an acidic condition. Because the battery is not in equilibrium (as explained in paragraph 31) and it takes time for a pH change at the cathode to diffuse through the entire electrolyte, the pH can also depend on the rate of discharging and/or the rate of charging. In addition, other factors can also affect the pH besides the charge rate, including the electrolyte volume and concentrations, the battery geometry, the amount of cathode material, temperature, etc.

In a non-limiting example, the electrolyte can include two or more buffers that allow the pH of the battery to be within a specific pH range during charging of the battery and within a specific different pH range during discharge of the battery. More specifically, through the choice of acids and conjugate bases used in the mixture of the electrolyte, the pH of the battery can be controlled such that the during charging of the battery, the pH is acidic and when discharging the battery, the pH is alkaline.

During discharge, the first buffer and/or the second buffer are part of reactions to generate protons and help to maintain the pH of the electrolyte at a desired alkaline level. During charging, the first buffer and/or the second buffer are part of reactions that utilize and/or consume protons and help to maintain the pH of the electrolyte at a desired acidic level.

In an illustrative example, the battery does not charge or discharge at equilibrium and there is an asymmetry in the charging and discharging of the battery. During discharge, the pH of the electrolyte in the battery goes above the pH range of the first buffer, even though there are two buffers, and the battery discharges at a pH more in the pH range of the second buffer. When the battery is charging, the pH of the electrolyte in the battery goes below the pH range of the second buffer and the battery discharges at a pH more in the pH range of the first buffer. Even though both buffers are in the electrolyte at the same time, the buffer that is further away from equilibrium, is more impactful at the condition around the cathode of the battery.

The first buffer and the second buffer are always, or almost always, available in the electrolyte and they are consumed during operation of the battery but the consumption of the buffers is not stable. In a specific example, the first buffer is an acid and conjugate base which operates around about 4.8 pH and the second buffer is a base and conjugate acid and operates around about 6 pH to about 7 pH. In an illustrative example, when discharging, the first buffer is active but the pH of the electrolyte raises past the pH range of the first buffer and the pH range of the electrolyte becomes a pH in the pH range of the second buffer due to the addition of protons during discharge that help to create an alkaline condition. The alkaline condition helps to increase the capacity of the battery. When charging the battery, the pH goes down and the pH of the electrolyte moves away from the pH range of the second buffer to the pH range of the first buffer as protons are utilized and/or consumed. The first buffer brings the pH of the electrolyte down to an acidic condition and the acidic condition helps to dissolve some of the oxides that were created during discharge of the battery.

The electrolyte can control the pH of the rechargeable battery such that the during charging, the pH is acidic and when discharging the pH is alkaline. For a rechargeable metal battery, the electrolyte in the battery can be configured such that when the metal is oxidized as the battery is discharged, the pH rises to an alkaline condition to help raise the capacity of the battery. When the battery is being recharged, the electrolyte is in an acidic condition and, rather than making a solid oxide when the battery is in an alkaline condition, the acidic condition helps the oxidized metal to dissolve into the electrolyte as a metal ion.

In some examples, the anode is a zinc anode and the cathode is a manganese cathode. More specifically, the anode is zinc foil and the cathode includes manganese oxide (MnO₂). To help the electrolyte control the pH of the battery such that during charging the pH is acidic and when discharging the pH is alkaline, the electrolyte can include acetate and sulfate in a range of about 0.3 moles or more of acetate to about 1 mole of sulfate or about 1 mole of acetate to about 0.3 moles or more of acetate. In a specific example, the electrolyte includes about 1 mole of acetate to about 1 mole of sulfate for a 1:1 ratio of acetate to sulfate.

During discharge of the battery, on the cathode side of the battery, the manganese oxide in the cathode reacts with protons to create manganese ions and create a lower potential (e.g., lower than 1.5 volts) at the cathode as compared to the potential at the anode.

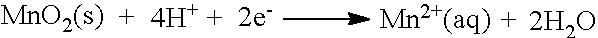

The manganese ions (Mn²⁺) react with hydroxide (2OH⁻) to undergo a reaction and create solid dense manganese oxides

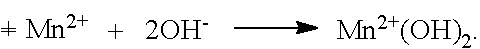

The loss of the protons during discharge of the battery raises the pH to an alkaline condition which helps increase the capacity of the battery as compared to if the battery was in an acidic condition.

On the anode side of the battery, the zinc in the zinc anode oxidizes to Zn ions and 2 electrons and a higher potential (e.g., higher than 1.5 volts) at the anode as compared to the potential at the cathode.

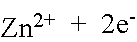

The zinc ions react with hydroxide in the electrolyte to undergo a reaction and create solid dense zinc oxides

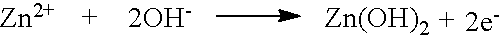

The first and second buffer helps keep the pH of the electrolyte at an alkaline condition during discharge.

During charging the same reactions occurs but in reverse.

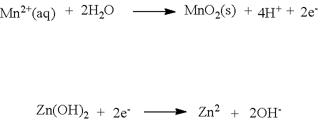

The gaining of the protons lowers the pH to an acidic condition and helps to dissolve the dense solid zinc oxides (e.g. Zn(OH)₂, manganese oxides (e.g., Mn(OH)₂), and possibly other material formed during the discharge of the battery and helps to free the zinc ions to return to the anode and the manganese ions to return to the cathode. The two buffer solutions of acetate and sulfate help keep the system within a pH range until the system runs out of buffer. More specifically, the acid and its conjugate base operate at the same pH level in equilibrium which is roughly the acid dissociation constant of the acetate or the sulfate. (e.g., pKa about 4.8 for acetic acid and for the sulfate acting as a conjugate acide the pKA is about 7 pr depending on the amount of the sulfate, can operate at about 5.5 pH to about 6 pH). Different pH buffers can be used to tune the pH ranges for other types of metal oxide batteries other than zinc batteries and the electrolyte can be tuned to the pHs that the metal oxide batteries will operate in.

In some examples, an electrical conditioning process for the battery can be added to the battery management system that is used to operate the battery and cycle between charges and discharges. During the electrical conditioning, a long discharge time (e.g., about 4 or more hours) as compared to the cycle time of the battery is performed at about 1.4 volts to about 1.8 volts to dissolve accumulated material on the cathode back into the electrolyte. More specifically, the electrical conditioning helps dissolve manganese, manganese oxides, and other material on the cathode such that the manganese is free to be deposited on the cathode and helps to increase the capacity of the battery. Also, the electrical conditioning helps dissolve or create manganese ions in the electrolyte and the manganese ions in the electrolyte can be deposited on the cathode and help increase the capacity of the battery. In some current batteries the electrolyte is just a charge carrier. As explained herein, the electrolyte can also supply manganese to the cathode because manganese is included in the electrolyte to help increase the capacity of the battery.

The electrical conditioning helps to avoid having to provide or add chemicals or modify assembly of the battery. The electrical conditioning can be performed after a predetermined number of cycles (e.g., 10 cycles, 20 cycles, etc.). After the electrical conditioning has been performed, the battery can return to cycling between charging and discharging and the assembly of the battery does not need to be modified and conditioning chemicals do not need to be added to the battery.

In some examples, the separator is a proton exchange membrane that can allow protons to move in the electrolyte and block bulky ions such as the manganese ions and zinc ions. Sometimes an additive in the electrolyte is good for the cathode but bad for the anode or good for the anode but bad for the cathode. For example, acetate can be good for the manganese cathode but can be harmful to the zinc anode while the sulfate can be good for the zinc anode but can be harmful for the manganese cathode. The proton exchange membrane allows for the electrolyte to be controlled on the cathode side and the anode side independently.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example. The term “about” includes a plus or minus twenty percent (±20%) variation. For example, about one (1) millimeter (mm) would include one (1) mm and ±0.2 mm from one (1) mm. Similarly, terms indicating orientation of various elements, for example, “coplanar,” “perpendicular,” “orthogonal,” “parallel,” or any other angle between the elements generally refer to being within plus or minus five to twenty percent (+/−5-20%) of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments.

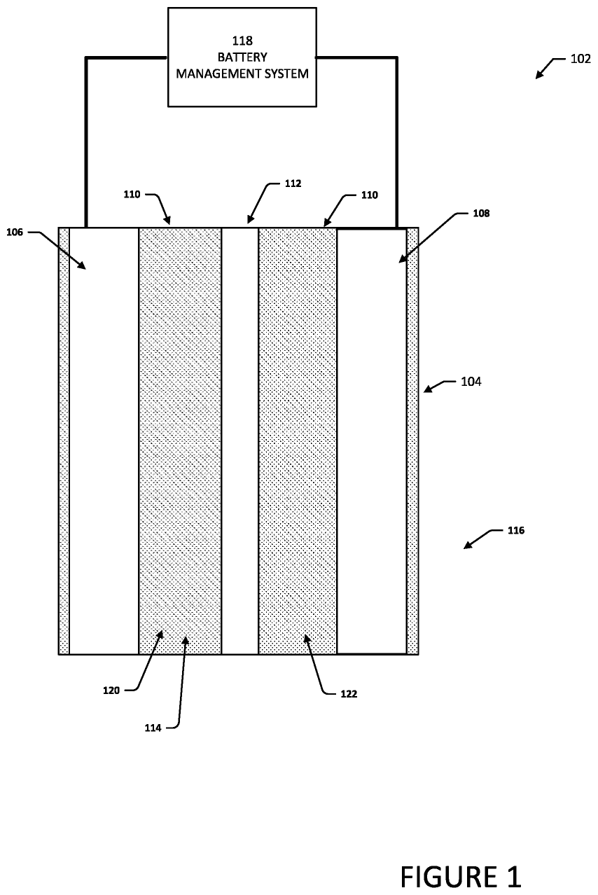

FIG. 1 is simplified block diagram of a battery 102, in accordance with an embodiment of the present disclosure. The battery 102 can include an outer casing 104, a cathode 106, an anode 108, an electrolyte 110, and a separator 112. The outer casing 104 defines an interior space 114 inside the battery 102. The interior space 114 includes the cathode 106, the anode 108, the electrolyte 110, and the separator 112 and helps keep the cathode 106, the anode 108, the electrolyte 110, and the separator 112 from being exposed to an outside environment 116. The outside environment 116 is the environment around the battery 102 or the environment outside of the outer casing 104. A positive terminal and the negative terminal (not shown) can extend from the outer casing 104 into the outside environment 116. The battery 102 is a “sealed” or “closed” battery meaning that during charging and discharging, no new material is added to the battery 102 and the battery 102 does not circulate electrolyte (e.g., with a pump or other means) or have ports, inlets, conduits, etc. for the addition of material to the battery 102. A battery management system 118 can control the cycling of the battery and testing of the battery's performance levels. The battery 102 can include a cathode area 120 that is close to or proximate to the cathode 106 and an anode area 122 that is close to or proximate to the anode 108. More specifically, the cathode area 120 is about half a distance or less between the cathode 106 and the separator 112 and the anode area 122 is about half a distance or less between the anode 108 and the separator 112.

In an example, the electrolyte 110 can include two or more buffers that control the pH of the battery such that during charging, the pH is acidic, in an acidic condition, and/or more acidic when compared to the pH when the battery is discharging, and when discharging the battery, the pH is alkaline, in an alkaline condition, and/or more alkaline when compared to the pH when the battery is charging. In a typical non-rechargeable battery, during discharge, the pH of the battery the pH does not change. More specifically, if the battery is an alkaline battery, the pH is relatively unchanged during discharge and stays alkaline. The active material interacts with the electrolyte and the active material is reduced in an oxidizing reaction where the active material is converted into a lower oxidation state that will no longer readily accept electrons.

In some examples, the electrolyte 110 in the battery 102 can include two or more buffers that control the pH of the battery 102 such that during charging of the battery 102, the pH is acidic and when discharging the battery 102, the pH is alkaline. By lowering the pH from alkaline to acidic during charging of the battery 102, the lower oxides dissolve, the active material can be redeposited onto the anode and/or cathode, and the battery 102 can be charged. During discharge of the battery 102, the pH can be raised from acidic to alkaline to help improved the capacity of the battery 102 and the battery 102 can be discharge again. By cycling from an alkaline pH during discharge, to an acidic pH during recharging, then back to an alkaline pH during discharge, the active material that normally cannot cycle can be made to cycle by dissolving the lower oxides of the active material. Because the battery is not in equilibrium and it takes time for a pH change at the cathode to diffuse through the entire electrolyte, the pH can also depend on the rate of discharging and/or the rate of charging. In addition, other factors can also affect the pH besides the charge rate, including the electrolyte volume and concentrations, the battery geometry, the amount of cathode material, temperature, etc.

In some examples, the battery 102 is an aqueous rechargeable battery (ARBs). For example, in a specific non-limiting implementation the anode 108 is a zinc based anode, the cathode 106 is a manganese oxide based cathode, and the electrolyte 110 can include an acetate and a sulfate. During discharge of the battery 102, the acetate can react with zinc ions to create zinc acetate, the acetate can react with manganese ions to create manganese acetates, protons can be consumed, and the pH can rise (from the acidic charging pH) to between about 4.5 to about 5.5 pH. During charging of the battery 102, the sulfate can react with zinc to create protons and bring the pH down to about 4.5 pH or below and allow the manganese oxides and zinc oxides to dissolve and free manganese ions to be deposited back onto the cathode and the zinc ions to be deposited back onto the anode.

The overall reaction during charging and discharging cycles is

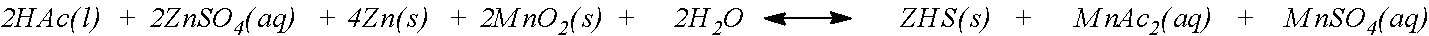

During the dissolution and deposition reactions when the battery is cycling through charging and discharging, protons are consumed and released meaning the pH during operation of the battery is not constant and the pH goes up and down. For example, during discharge, protons are consumed and the pH goes up and when charging, protons are released and the pH goes down. More specifically, when charging the battery at a voltage range of about 1 volt to about 2.1 volts, protons are released (Mn²⁺(aq)+2H₂O→MnO₂(s)+4H⁺+2e⁻) and the pH is lowered to an acidic condition. The acidic condition helps to dissolve at least some of the by-products (oxides) created during discharge to release manganese ions and zinc ions. The acidic condition also favors growing the particularly stable higher oxides such as MnO₂ by dissolving at least some of the insulating lower oxides Mn(OH)₂, Mn₂O₃, and Mn₃O₄. at least some of the manganese ions can be deposited back onto the cathode and a least some of the zinc ions can be deposited back onto the anode. During discharge, the protons are lost or consumed and the pH rises to an alkaline condition and helps to dissolve the manganese ions and zinc ions back into the electrolyte. When the voltage of the battery reaches a range of about 1.2 volts to about 1.5 volts, the zinc ions start to react with hydroxide and the sulfate ions to form zinc hydroxide sulfate which is a by-product.

In some examples, an electrical conditioning of the battery 102 can be added to the battery management system 118 that is used to operate the battery 102 and cycle between charges and discharges. During the electrical conditioning, a long discharge time (e.g., about 4 or more hours), as compared to the cycle time of the battery, is performed at about 1.4 volts to about 1.8 volts to dissolve at least some of the accumulated material on the cathode back into the electrolyte. More specifically, the electrical conditioning can help dissolve manganese, manganese oxides, and other material on the cathode so the manganese is free to be deposited on the cathode and help increase the capacity of the battery. Also, the electrical conditioning helps dissolve or create manganese ions in the electrolyte so the manganese ions from the electrolyte can be deposited on the cathode and help increase the capacity of the battery. The electrical conditioning helps to avoid having to provide or add chemicals or modify assembly of the battery 102. The electrical conditioning can be performed after a predetermined number of cycles (e.g., 10 cycles, 20 cycles, etc.). After the electrical conditioning has been performed, the battery 102 can return to cycling between charging and discharging.

In some examples, the separator 112 is a proton exchange membrane that can allow protons to move in the electrolyte but bulky ions such as the manganese ions and zinc ions are blocked. Acetate can be good for the manganese cathode but can be harmful to the zinc anode while the sulfate can be good for the zinc anode but can be harmful for the manganese cathode. The proton exchange membrane allows for the electrolyte to be controlled on the cathode side and the anode side independently such that the acetate is confined to the cathode side of the battery and the sulfate is confined to the anode side of the battery.

It is to be understood that other embodiments may be utilized and structural changes may be made without departing from the scope of the present disclosure. Substantial flexibility is provided by the battery and/or the electrode in that any suitable arrangements and configuration may be provided without departing from the teachings of the present disclosure.

For purposes of illustrating certain example techniques of the battery 102, the following foundational information may be viewed as a basis from which the present disclosure may be properly explained. A number of prominent technological trends are currently afoot and these trends are changing the power delivery landscape. The growing energy demands and the increasing environmental concerns drive the transformation of power generation from primarily fossil and nuclear sources to solely renewable energy sources and the search of efficient energy management systems (conversation, storage and delivery), to achieve a secure, reliable and sustainable energy supply. The success is strongly dependent on the achievements in efficient electrochemical power sources that are also safe to operate, economically viable, and environmentally friendly. One type of reliable and sustainable energy supply is a rechargeable battery that can delivery electrical power when needed and then recharge so the battery is available to provide the electrical power the next time it is needed.

Generally, a battery is a device that stores chemical energy and converts it to electricity. This is known as electrochemistry and the system that underpins a battery is called an electrochemical cell. A battery can be made up of one or several electrochemical cells. Each electrochemical cell consists of two electrodes, an anode and a cathode, separated by an electrolyte.

The battery includes chemicals that undergo a reduction-oxidation reaction or more commonly a redox reaction that involves the exchange of electrons. More specifically, two half-reactions occur, and in the case of an electrochemical cell, one half-of the reaction occurs at the anode, the other half of the reaction occurs at the cathode. At the anode, a chemical reaction occurs that produces electrons and the electrons accumulate at the anode. At the cathode, a simultaneous chemical reaction occurs that enables the cathode to accept electrons. The cathode is reduced during the reaction and undergoes a reduction reaction where electrons are gained by the cathode. The anode is oxidized during the reaction and undergoes an oxidation reaction where electrons are lost by the anode.

The cathode plays an important role in determining the characteristics of the battery as the battery's capacity and voltage are determined by the active material used for the cathode. The higher the amount of available active material, the higher the capacity of the battery. Also, the higher the amount of available active material, the greater the potential difference can be between the cathode and the anode, resulting in a higher the voltage of the battery. In general, the potential difference is relatively small for the anode as compared to the cathode, depending on the type of anode. As such, the cathode plays a significant role in determining the voltage of the battery. The key in enabling the use of electricity in a battery is that cations (e.g., metal ions, protons) move through the electrolyte and electrons move through the conductive wire connected to the battery. The electrolyte is the component that serves as the medium that enables the movement of the protons between the cathode and the anode.

Any two conducting materials that have reactions with different standard potentials can form the cathode and anode of an electrochemical cell because the cathode will be able to take electrons from the anode. A good choice for an anode is a material that produces a reaction with a significantly lower (more negative) standard potential than the material that is chosen for the cathode. This allows electrons to be attracted to the cathode from the anode and when the electrons are provided with a pathway to travel from the anode to the cathode, the flow of the electrons can provide electrical power.

The electrolyte can be a liquid, gel or a solid substance that allows for the movement of charged ions. Electrons have a negative charge, and because the flow of negative electrons travels through the circuit, the flow or movement of the negative charge needs to be balanced by positive ions. The electrolyte provides a medium through which charge-balancing positive ions can flow. As the chemical reaction at the anode produces electrons, to maintain a neutral charge balance on the electrode, a matching amount of positively charged ions are also produced at the cathode. The positively charged ions do not travel along the pathway that the electrons travel (e.g., a wire connection) but are instead released into the electrolyte. While the pathway (e.g., wire) provides for the flow of negatively charged electrons, the electrolyte provides the pathway for the transfer of positively charged ions to balance the negative flow. This flow of positively charged ions is just as important as the electrons that provide the electric current in the external circuit used to power devices. The charge balancing is necessary to keep the entire reaction in the battery running.

When a rechargeable battery that does not have a charge or is not fully charged is connected to an external electricity source and energy is sent back in to the battery, the energy in to the battery reverses the chemical reaction that occurred during discharge. This sends the positive ions released from the anode into the electrolyte back to the anode and the electrons that the cathode took in are also sent back to the anode. The return of both the positive ions and electrons back into the anode primes the system and the battery is recharged.

Rechargeable battery technologies including lead-acid (Pb-acid), nickel-cadmium (Ni—Cd), nickel-metal hydride (Ni-MH), redox flow-cells (RFCs) and lithium-ion batteries (LIBs) have found practical applications in various areas, however, the inherent limitations of these systems impede their applications in large-scale energy storage. For example, operational safety is of prime importance along with other desirable characteristics such as low installed cost, long cycling life, high energy efficiency and sustainability. More specifically, Pb-acid and Ni—Cd generally suffer from the limited energy density (˜30 Wh kg-1), as well as the use of environmentally threatened electrode materials. A nickel-iron battery is challenged by the poor charge/discharge efficiency (ca. 50-60%) and the self-discharge (20-40% per month) related to the corrosion and poisoning of the iron anode. A Ni-MH possesses higher energy density, but delivers poor low-temperature capability, limited high-rate capability, and poor Coulombic efficiency. Redox-flow cells can be easily linked together, however, the relatively low power/energy density and the special heat/temperature control requirements limit their use. Lithium-ion batteries hold great promise, benefiting from higher energy density, lighter weight and longer life time, however, incidents caused by the flammability of the organic electrolyte and the reactivity of the electrode materials with the organic electrolytes in the case of overcharging or short-circuiting raise serious safety concerns. In addition, lithium-ion battery technologies have a comparatively high cost due to the materials used (organic Li salts and organic electrolytes), the special cell designing and manufacturing processes, and auxiliary systems required for their operation. Another challenge regarding lithium-ion batteries is the limited rate capability and specific power that are restricted by the limited ionic conductivities of the organic electrolyte.

Some rechargeable metal batteries are highly acidic and have a low pH (e.g., pH around 2). The highly acidic batteries dissolve the by-products formed during discharge, however, the highly acidic conditions in the battery it cause the metal (e.g., zinc) to form dendrites and the battery has to be discharged after every few days.

Other rechargeable metal batteries are highly alkaline and have a high pH (e.g., pH around 12). A highly alkaline battery is corrosive and the high pH is helpful to maintain the metal material and allow the metal material to be recoverable. However, highly alkaline batteries do not have a high capacity. After a few years, the highly alkaline batteries need to be drained and refilled causing both economic and environmental concerns. What is needed is a battery that is relatively safe to operate, economically viable, and environmentally friendly.

A system, method, apparatus, means, etc. to help enable a battery that is relatively safe to operate, economically viable, and environmentally friendly can help resolve these issues (and others). In an example, a battery (e.g., battery 102a) can include a cathode (e.g., the cathode 106), an anode (e.g., the anode 108), an electrolyte (e.g., the electrolyte 110), and a separator (e.g., the separator 112). In some examples, the separator is a proton exchange membrane that can allow protons to move in the electrolyte and block bulky ions from moving across or through the separator. The proton exchange membrane allows for the electrolyte to be controlled on the cathode side and the anode side independently.

In some examples, the electrolyte in the battery can be a mixture that allows for dissolution and deposition reactions during charging and discharging of the battery. In an example, the electrolyte controls the pH of the battery such that the during charging of the battery, the pH is acidic, in an acidic condition, and/or more acidic when compared to the pH when the battery is discharging, and when discharging the battery, the pH is alkaline, in an alkaline condition, and/or more alkaline when compared to the pH when the battery is charging. In a non-limiting example, the electrolyte can include two or more buffers that allow the pH of the battery to be within a specific pH range during charging of the battery and within a specific different pH range during discharge of the battery. More specifically, through the choice of acids and conjugate bases used in the mixture of the electrolyte the electrolyte can control the pH of the battery such that the during charging of the battery, the pH is acidic and when discharging the battery, the pH is alkaline.

For a rechargeable metal battery, the electrolyte in the battery can be configured such that when the metal is oxidized as the battery is discharged, the pH is in an alkaline condition to help raise the capacity of the battery. When the battery is being recharged, the electrolyte is in an acidic condition and, rather than making a solid oxide when the battery is in an alkaline condition, the metal dissolves into the electrolyte as a metal ion.

In some examples, the anode is a zinc anode and the cathode is a manganese cathode. More specifically, the anode is zinc foil and the cathode includes manganese oxide (MnO₂). To help the electrolyte control the pH of the battery such that the during charging, the pH is acidic and when discharging the pH is alkaline, the electrolyte can include acetate and sulfate in a range of about 0.3 moles or more of acetate to about 1 mole of sulfate or about 1 mole of acetate to about 0.3 moles or more of acetate. In a specific example, the electrolyte includes about 1 mole of acetate to about 1 mole of sulfate for a 1:1 ratio of acetate to sulfate.

In some examples, an electrical conditioning process for the battery can be added to the battery management system that is used to operate the battery and cycle between charges and discharges. During the electrical conditioning, a long discharge time (e.g., about 4 or more hours) as compared to the cycle time of the battery, is performed at about 1.4 volts to about 1.8 volts to help dissolve at least a portion of the accumulated material on the cathode back into the electrolyte. More specifically, the electrical conditioning helps dissolve oxides, and other material on the cathode such that the cathode material is free to be deposited on the cathode and help increase the capacity of the battery.

The anode includes a material (anode active material) that reacts with the electrolyte in a reaction (oxidation) that produces electrons and the electrons accumulate at the anode. More specifically, the anode can include an active anode material such as zinc (Zn), silicon (Si), copper (Cu), Aluminum oxide (Al₂O₃), zinc oxide (ZnO), lead (Pb), Aluminum (Al), nickel (Ni), bismuth (Bi), tin (Sn), molybdenum disulfide (MoS2), Indium (In), and their alloys or composites or some other material that reacts with the electrolyte in a reaction (oxidation) that enables the anode to produce electrons.

The cathode includes a material (cathode active material) that reacts with the electrolyte in a reaction (reduction) that enables the cathode to accept electrons. More specifically, the cathode can include an active cathode material such as manganese oxide (MnO2), bismuth oxide (Bi2O3), vanadium oxide (V2O5), lead oxide (PbO), iron oxide (Fe2O3), zinc hexacyanoferrate (ZnHCF), copper hexacyanoferrate (C6CuFeN6), prussian blue (Fe4[Fe(CN)6]3), molybdenum disulfide (MoS2), molybdenum diselenide (MoSe2), tungsten disulfide (WS2), or some other material that that reacts with the electrolyte in a reaction (reduction) that enables the cathode to accept electrons. Note that the active electrode material chosen for the anode and cathode depends on the material in the cathode and anode because any two conducting materials that have reactions with different standard potentials can form the cathode and anode of an electrochemical cell.

In some examples, the substrate of the anode and/or the cathode can include a porous material. The active material (anode active material and/or cathode active material) can be can applied to the porous material using coating methods such as wet-chemical reaction or deposing methods including brush painting, spin coating, blade coating, dip-coating, hot-dipping, electroplating, pulse electroplating, electrodeposition, constant voltage electrodeposition, constant current electrodeposition, pulse electrodeposition, cyclic voltammetric deposition, electrophoretic deposition, sputtering, or some other means of applying the active material to or coating, depositing, growing, etc. the active material on the porous material.

The porous material can include copper foam, nickel foam, stainless steel foam, titanium foam, carbon felt, carbon cloth, carbon paper conductive polymers, or some other type of material that can provide a conductive surface area for the active electrode materials. For the anode, the active material can include zinc (Zn), silicon (Si), copper (Cu), aluminum oxide (Al₂O₃), zinc oxide (ZnO), lead (Pb), Aluminum (Al), nickel (Ni), bismuth (Bi), tin (Sn), MoS₂, In, and their alloys or composites or some other material that reacts with the electrolyte in a reaction (oxidation) that enables the anode to produce electrons. For a cathode, the active material can include manganese oxide (MnO₂), bismuth oxide (Bi₂O₃), vanadium oxide (V₂O₅), lead oxide (PbO), iron oxide (Fe₂O₃), zinc hexacyanoferrate (ZnHCF), copper hexacyanoferrate (C₆CuFeN₆), prussian blue (Fe₄[Fe(CN)₆]₃), molybdenum disulfide (MoS₂), molybdenum diselenide (MoSe₂), tungsten disulfide (WS₂) or some other material that that reacts with the electrolyte in a reaction (reduction) that enables the cathode to accept electrons. Note that the active electrode material chosen for the anode (or cathode) depends on the material in the cathode (or anode) because any two conducting materials that have reactions with different standard potentials can form the cathode and anode of an electrochemical cell as the stronger material, the cathode, will be able to take electrons from the weaker material, the anode.

In some examples, the porous material can include a conductive fluid. The conductive fluid can be conductive ink or some other type of conductive fluid that can help increase the conductivity of the porous material. In some examples, the conductive fluid is a mixture of a binder, electrically conductive material, and a solvent. The binder can include binder Polyvinylidene fluoride (PVDF), Polytetrafluoroethylene (PTFE), Polyvinyl butyral (PVB), Carboxymethyl cellulose (CMC), polyvinylpyrrolidone, ethyl cellulose, Styrene-Butadiene Rubber (SBR), Poly(ethylene oxide) (PEO) or some other similar type binder. The electrically conductive material can include carbon black, conductive graphite, carbon nanotube, activated carbon, amorphous carbon, electrically conductive polymer, metal particle such as zinc, nickel, chromium, copper, aluminum, stainless steel or some other similar type of conductive material, preferably a non-corrosive type of conductive material. The solvent can include N-Methyl-2-Pyrrolidone (NMP), ethanol, acetone, Isopropyl alcohol, 4-hydroxy-4-methyl-2-pentanone, ethyl alcohol, water, or some other similar type of solvent. The conductive fluid may be applied to the porous material using brush painting, spin coating, soak coating, blade coating, dip-coating, electroplating, pulse electroplating, electrodeposition, constant voltage electrodeposition, constant current electrodeposition, pulse electrodeposition, cyclic voltammetric deposition, sputtering, electrophoretic deposition, or some other means of applying the conductive fluid to the porous material.

The electrolyte can be designed or formulated to control the pH of the battery such that the during charging, the pH is acidic and when discharging the pH is alkaline. In a non-limiting specific example, the electrolyte can be designed or formulated to maintain the purity of zinc and manganese ions during charging and discharging. In some examples, the electrolyte can be formulated to include about 0.3 to about 1 mole of acetate per mole of sulfate (a 0.3:1 ratio or higher) with about 1 to 3 moles of sulfate per liter. In other examples, the electrolyte can be formulated to include about 1 mole of acetate per about 0.3 to about 1 mole of sulfate (a 1:0.3 ratio or higher) with about 1 to 3 moles of acetate per liter. In a specific example, the electrolyte can be formulated to include 1 mol of zinc sulfate and 1 mole of zinc acetate per liter and 0.1 moles of manganese sulfate and 0.1 moles of manganese acetate, 2 moles of zin ions per liter, and 0.2 moles of manganese ions per liter, in a 1:1 ratio. The electrolyte with the manganese and the sulfate can help preserve the cathode and also maintain a high capacity of the battery. By buffering the pH, when the battery is cycled, the pH can be controlled by the material in the electrolyte. The electrolyte disclosed herein is applicable to other batteries and the electrolyte can be formulated to control the pH of the battery such that the during charging, the pH is acidic for batteries other than zinc based batteries.

If just sulfate is used as the buffer, zinc sulfate and manganese sulfate are formed which are an irreversible by-product that traps the zinc ions and the manganese ions and the capacity of the battery decreases. In a pure sulfate system, when the battery is charged, the zinc gets trapped with the manganese and oxygen and forms ZnMn₂O₄ or the manganese gets transferred to other insulating material (e.g., MnOOH or Mn₃O₄, or other manganese oxides) and once the ZnMn₂O₄ and/or manganese oxides form on the cathode they remain on the cathode. Then, during the next charging and discharging cycle, there is reduced space on the cathode and the capacity of the battery is lowered. As a result, batteries where the electrolyte includes sulfate typically have a low pH and low capacity as compared to batteries that have a higher pH. If just acetate is used, the pH is over 5.5 and the battery can generate a relatively high capacity, as compared to a battery that uses a lower pH, but the acetate does not dissolve the manganese back into the electrolyte during discharge because the pH is too high.

With the acetate sulfate combination in the electrolyte, when the manganese moves into deposition, a majority of or at least some of the acetate ions bind to the surface of the manganese and keep the manganese protected during charging of the battery and at least a portion of the manganese does not react with any of the hydrogen or oxygen species to form the by-products because the manganese is not freely available and the acetate protects the manganese. Then during the dissolution, the acetate is released from the manganese and reacts with the water to create acetic acid. The acidic acid can help limits the by-products from manganese reactions. Also, during charging of the battery protons are generated. The protons help lower the pH to an acidic condition that can help dissolve the by-products to release the manganese ions and zinc ions and the manganese ions can be deposited back onto the cathode and the zinc ions can be deposited back onto the anode. More specifically, when charging the battery at a voltage range of about 1 volt to about 2.1-volts, the manganese and zinc ions are deposited back onto the electrodes.

During discharge, the protons are lost and that raises the pH (from the acidic condition during charging) to an alkaline condition. The alkaline condition helps to dissolve the manganese ions from the cathode and the zinc ions from the anode back into the electrolyte. When the voltage of the battery reaches a range of about 1.2 to about 1.5 volts, the zinc starts to react with the hydrogen and the sulfate starts to form zinc hydroxide sulfate which is part of the by-product discussed above.

During the dissolution and deposition reactions during charging and discharging of the battery, protons are consumed and released meaning the pH during operation of the battery is not constant and the pH moves up and down. More specifically, during discharge, protons are consumed and the pH moves up and when charging, protons are released and the pH moves down. Dissolution refers to the process of dissolving a solute into a solvent to make a solution. Metal deposition and dissolution usually involve more than a simple discharge or formation of hydrated metal ions. In most practical cases, reactions of complex dissociation or formation occur simultaneously as well as deposition and incorporation of foreign substances (impurities or additives), etc. that affect the structure and appearance of the deposit obtained. On a metal electrode, all surface sites are equivalent and during deposition of a metal ion from the electrolyte, the ion loses a part of its solvation sheath, is transferred to the metal surface of the electrode, and is discharged. After a slight rearrangement of the surface atoms, the metal ion is incorporated into the electrode.

In some examples, the battery can be used in an aqueous rechargeable battery. Aqueous rechargeable batteries (ARBs) are particularly suited for large-scale energy storage in terms of safety, economics, and sustainability. More specifically, aqueous rechargeable batteries are inherently safe because the aqueous electrolyte does not require the usage of flammable organic electrolytes. Also, the ionic conductivities of the aqueous electrolyte is about two orders of magnitude higher than that of nonaqueous electrolytes, helping to ensure a relatively fast charge and discharge and high round-trip efficiency as compared to nonaqueous electrolytes. Further, the electrolyte salt and solvent in the aqueous electrolyte are typically less expensive as compared to nonaqueous electrolytes and the rigorous manufacturing requirements of nonaqueous electrolytes are avoided. In addition, aqueous electrolytes are generally environmentally benign.

The first aqueous rechargeable batteries used LiMn2O4 as the positive electrode and β-VO2 as the negative electrode. In the first aqueous rechargeable batteries, metal-ions were intercalated into or extracted from the active materials during charge/discharge processes, similar to that of organic systems. The first aqueous rechargeable batteries are often referred to as “rocking chair” type aqueous rechargeable batteries or “intercalation-chemistry” type aqueous rechargeable batteries. Since the creation of the first aqueous rechargeable batteries, significant progresses have been made as more electrochemical redox couples are identified, more insights into fundamental chemistry are gained, and new battery chemistries are explored. More recently, a hybrid design that involves coupling an intercalation cathode with a metal anode or combining an intercalation anode with a metal oxides/sulphide has been introduced in aqueous rechargeable batteries with the appearance of a new class of aqueous hybrid batteries systems such as LiMn₂O₄//Zn, Na_{0.44}MnO₂//Zn, Na_{0.61}Fe_{1.94}(CN)₆, Ni(OH)₂//TiO₂, and CoₓNi₂₋ₓS₂//TiO₂, MnO₂//Zn. Different from the “rocking chair” type aqueous rechargeable batteries, the new class of aqueous rechargeable batteries operate based on two reversible electrochemical redox processes involving the anode and cathode electrodes separately and the charge/discharge mechanism in one or two electrodes is not guest ion intercalation/de-intercalation. Instead, the reversible electrochemical redox processes can be the reaction of Zn2+ deposition-dissolution and/or proton-induced oxidization/reduction. The electrolyte in the new class of aqueous rechargeable batteries acts as conducting ions and cooperates with the electrodes to store energy, rather than used as the simple supporting media as in “rocking chair” type aqueous rechargeable batteries.

Since electrochemical redox reactions involved in an aqueous rechargeable battery take place in a water environment, the electrochemical stability window is generally limited to be 1.23 V, beyond which H₂O is electrolyzed with O₂ or H₂ gas evolution. Thus, materials with working potentials located between the H₂ evolution potential and O₂ evolution potential are promising electrode candidates for aqueous rechargeable batteries. In principle, electrodes with a working potential between 3 and 4 V (vs. Li+/Li) can be used as a cathode and electrodes with a working potential between 2 and 3 V (vs. Li+/Li) can be chosen as an anode. It should be noted that the H₂ evolution potential and O₂ evolution potential are strongly dependent on pH value and special caution should be given for electrode materials selection to avoid water decomposition. The electrochemical stability window limits the achievable energy density as the energy per electron for aqueous batteries is much lower than the energy per electron for non-aqueous battery. For example, a Li ion battery typically has a voltage window above 3.5 V while the voltage window for an aqueous battery is often below 3 V. Therefore, it is critical for aqueous rechargeable battery to obtain high areal capacity to improve the overall energy density.

Rechargeable batteries based on multivalent metal ions insertion/extraction in an aqueous solution, such as Mg2+, Ca2+, Zn2+, and Al3+, are considered to be one of the most promising aqueous rechargeable battery systems due to the potential two-to-three-fold high energy density as compared to monovalent aqueous rechargeable batteries. The water molecules can effectively shield the electrostatic repulsion of multivalent ions and lower the activation energy for charge transfer at electrode/electrolyte interface as compared to an organic solution. Thus, the multivalent aqueous rechargeable batteries can often deliver better electrochemical properties than organic rechargeable batteries.

Metallic zinc (Zn) is a promising anode candidate for aqueous batteries because of its low equilibrium potential (−0.762 V vs. SHE), high specific energy density (825 mAh g-1), and abundance and low toxicity. Different from the “rocking chair” type batteries, exchange of Li+ and Zn2+ ions in mild acidic aqueous electrolyte occurs upon charging/discharging. The electrolyte here acts as conducting ions and cooperates with the electrodes to store energy, rather than acting as the simple supporting media in “rocking chair” type batteries. The electrochemical reaction between the LiMn₂O₄ cathode and zinc (Zn) metal anode can be expressed as follows:

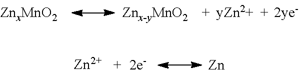

In some examples, adding carbon additives into a porous zinc (Zn) anode can help to improve the discharge capacity as well as the cycling stability of the zinc (Zn) anode. The improvement can be attributed to the carbon coating of the zinc (Zn) particle surface that prevents the direct contact of the zinc (Zn) anode with the electrolyte, and thus the corrosion of the active zinc (Zn) particle is restrained. In addition, the pores of activated carbon can accommodate the deposition of zinc (Zn) dendrites and insoluble anodic products, giving an increase in cycling stability. Organic additives can also be added to help suppress the dendrite formation and corrosion of zinc (Zn) anode upon cycling.

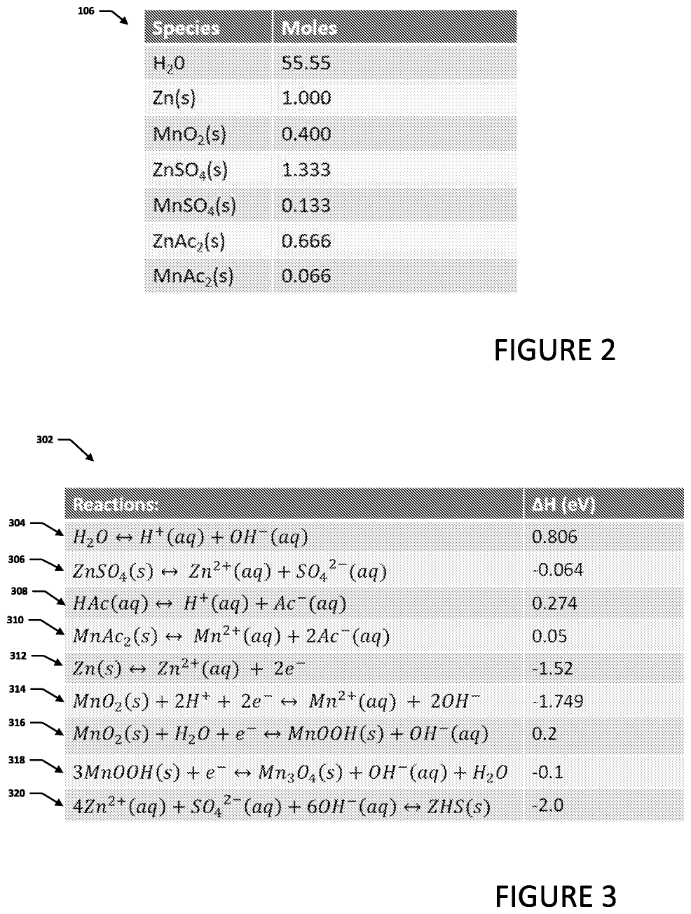

Turning to FIG. 2, FIG. 2 illustrates example non-limiting details of an initial concentration of the material in an electrolyte (e.g., the electrolyte 110), in accordance with an embodiment of the present disclosure. In the specific non-limiting example illustrated in FIG. 2, the electrolyte, per 1 L of solution (water), can include 55.55 moles of water (H₂O), 1 mole of Zn, 0.4 moles of manganese dioxide (MnO₂), 1.3 mole of zinc sulfate (ZnSO₄), 0.133 moles of manganese sulfate (MnSO₄), 0.67 moles of zinc acetate (ZnAc₂), and 0.067 moles of manganese acetate (MnAc₂). Note that the amounts illustrated in FIG. 2 are only an examples and other amounts may be used in accordance with an embodiment of the present disclosure.

Turning to FIG. 3, FIG. 3 illustrates example non-limiting details of some of the reactions that occur, in accordance with an embodiment of the present disclosure. The reactions illustrated in FIG. 3 are based on the concentration of the material in the electrolyte illustrated in FIG. 2. Note that the reactions may be different if amounts other than the amounts illustrated in FIG. 2 are used in the electrolyte.

Reaction 304 is an electrolysis reaction and illustrates, on charging of the battery 102, H₂O is split into H⁺(aq) and OH⁻(aq) and during discharge, the opposite reaction occurs where H⁺(aq) and OH⁻(aq) are combined into H₂O. Reaction 306 illustrates, during charging, ZnSO₄(s) is dissolved into Zn²⁺(aq) and SO₄²⁻(aq), allowing the zinc ions to separate from the sulfate and during discharge, the Zn²⁺(aq) and SO₄²⁻(aq) combine to form ZnSO₄(s). Reaction 308 illustrates, during charging, HAc(aq) is separated to form H⁺(aq) and Ac⁻(aq) and during charging, the H⁺(aq) and Ac⁻(aq) combine for form HAc(aq). Reaction 310 illustrates, during charging, MnAc₂(s) is separated into Mn²⁺(aq) and 2Ac⁻(aq) and during discharge the Mn²⁺(aq) and 2Ac⁻(aq) combine to form MnAc₂(s). Reaction 312 illustrates, during charging Zn(s), undergoes an oxidation reaction and produces Zn²⁺(aq) and 2e⁻ and during discharge, the Zn²⁺(aq) and 2e⁻ combine to form Zn(s). Reaction 314 illustrates, during charging MnO₂(s) is combined with 2H⁺ and 2e⁻ to produce Mn²⁺(aq) and 2OH⁻ and during discharge, the Mn²⁺(aq) and 2OH⁻ combine to produce MnO₂(s), 2H⁺, and 2e⁻. Reaction 316 illustrates, during charging, MnO₂(s) is combined with H₂O and an e⁻ to produce MnOOH(s) and OH⁻(aq) and during discharge, the MnOOH(s) and OH⁻(aq) combine to produce MnO₂(s), H₂O, and an e⁻. Reaction 318 illustrates, during charging, 3MnOOH(s) is combined with an e⁻ to produce Mn₃O₄(s), OH⁻(aq), and H₂O and during discharge, the Mn₃O₄(s) combines with OH⁻(aq) and H₂O to produce 3MnOOH(s). Reaction 320 illustrates, during charging, 4Zn²⁺(aq) reacts with SO₄²⁻(aq) and 6OH⁻(aq) to produce ZHS(s) and during discharge, the ZHS(s) is broken down into 4Zn²⁺(aq), SO₄²⁻(aq), and 6OH⁻(aq).

The Ac⁻(aq) from the reactions 308 and 310 and the SO₄²⁻(aq) from reaction 306 are part of the two or more buffers in the electrolyte and can be added to the electrolyte as a solid or in an aqueous solution. The ZHS from reaction 320 can act as an additional proton source during discharge of the battery. The ZHS can form at the bottom of discharge and helps prevent the system from becoming alkaline. In addition, the ZHS can simplify the overall reaction, replacing uncoordinated species, and halving the number of protons that need to be contributed to the reaction from other proton sources.

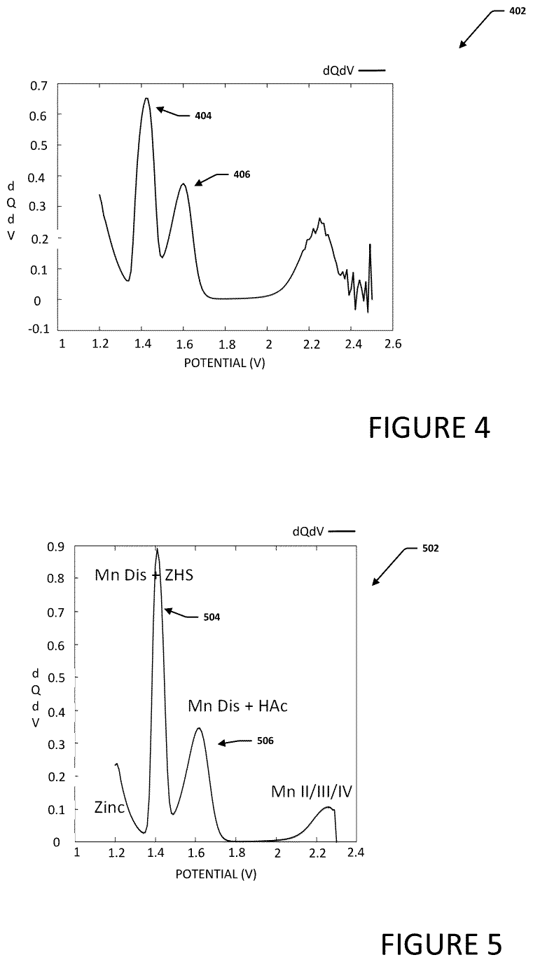

Turning to FIG. 4, FIG. 4 illustrates a graph 402 showing example non-limiting details related to the generation of protons by an electrolyte mixture, in accordance with an embodiment of the present disclosure. In an illustrative example, when two buffers are used in the electrolyte and the buffers are active are active, each of the buffers can generate protons. More specifically, as illustrated by a first peak 404 in graph 402, when the pH of the electrolyte is within the pH range of a first buffer, the first buffer is active and can generate protons to help increase the capacity of the battery. As the pH shifts from the pH range of a first buffer to the pH range of the second buffer, as illustrated by a second peak 406 in graph 402, the second buffer is active and can generate protons to further help increase the capacity of the battery.

Turning to FIG. 5, FIG. 5 illustrates a graph 502 showing example non-limiting details related to the generation of protons by an electrolyte mixture that includes sulfate and acetate as the two buffers in the electrolyte, in accordance with an embodiment of the present disclosure. As illustrated in FIG. 5, a manganese dissolution/deposition has 2 separate peaks 504 and 506 depending on hydrogen source (and pH). More specifically, the peaks 504 and 506 illustrated in FIG. 5 appear to be between about 1.4 volts and about 1.8 volts. The areas of the 1.6 V and 1.4 V peaks are nearly equal, meaning HAc and ZHS are providing an equal number of protons. With a greater number of protons in the pH buffer, the HAc peak 506 becomes more dominant. At about 2 M HAc, the ZHS peak 504 is completely gone and ZHS formation is no longer necessary to complete the dissolution.

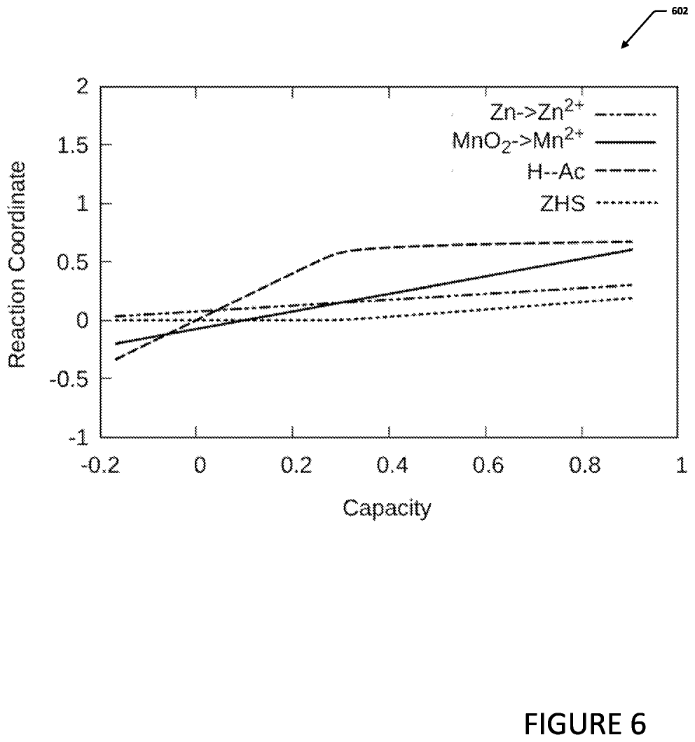

Turning to FIG. 6, FIG. 6 illustrates a graph 602 showing example non-limiting details related to the ranges of chemical reactions inside the battery 102, in accordance with an embodiment of the present disclosure. The pH range during the reactions was around 4 pH to about 7 pH. The acidic acid buffer was active around about 4 pH to about 5 pH and the ZHS buffer was active around about 6 pH to about 7 pH. Graph 602 illustrates that the distinct ranges of chemical reactions in the battery 102 coincide with the observed peaks illustrated in FIGS. 4 and 5. Graph 602 helps to illustrate that the observed peaks illustrated in FIGS. 4 and 5 are the distinct ranges of the buffers in the electrolyte and not peaks are from different species of Zn or Mn.

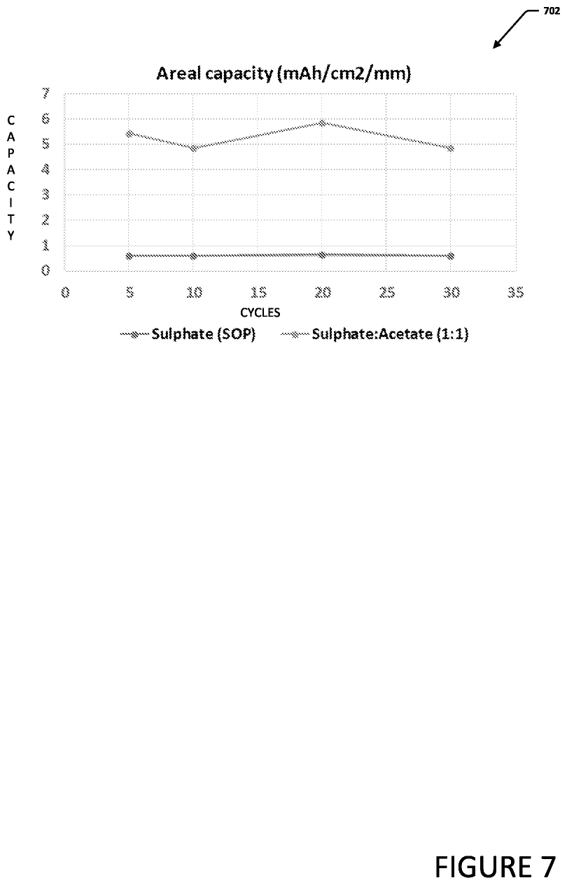

Turning to FIG. 7, FIG. 7 illustrates a graph 702 showing example non-limiting details related to the generation of protons by an electrolyte mixture using one buffer as compared to using two buffers, in accordance with an embodiment of the present disclosure. As illustrated in FIG. 7, when only one buffer is used, for example, sulphate, the capacity of the battery is relatively low as compared to when two buffers are used. More specifically, when sulphate and acetate are used as buffers in a 1:1 ratio, the capacity of the battery is much higher when compared to only using the single sulfate buffer.

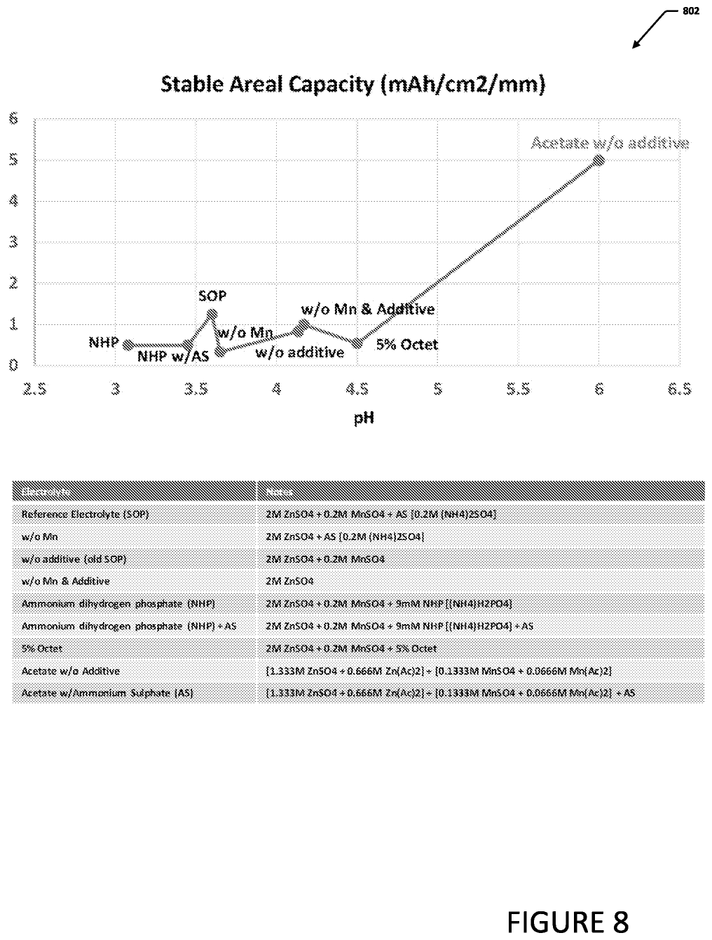

Turning to FIG. 8, FIG. 8 illustrates a graph 802 showing example non-limiting details related to how pH value (X-Axis) affects the areal capacity (Y-axis) generation, in accordance with an embodiment of the present disclosure. As illustrated in FIG. 8, with a manganese zinc battery, the pH is very sensitive in terms of the capacity. The electrolyte can have the buffers present but if the buffers are not allowing for the desired pH, the buffers will not provide any benefit for the battery capacity. More specifically, when the buffer chemistry reaches pH 5.5 or pH 6, a higher capacity for the battery is achieved that is not possible with any of the other buffer chemistries.

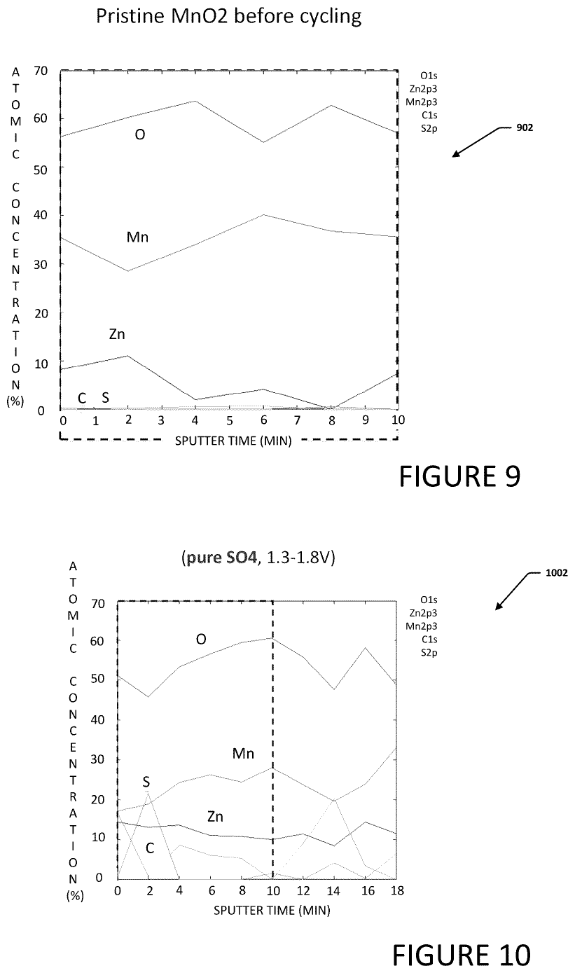

Turning to FIG. 9, FIG. 9 illustrates a graph 902 showing example non-limiting details related to species on the cathode, in accordance with an embodiment of the present disclosure. Graph 902 illustrates the species on the cathode before the electrolyte is added and before the battery is starting to cycle.

Turning to FIG. 10, FIG. 10 illustrates a graph 1002 showing example non-limiting details related to the species on the cathode after cycling a battery with only one buffer (sulfate) in the electrolyte, in accordance with an embodiment of the present disclosure. As illustrated in graph 1002, as the battery cycles, more and more sulfate becomes accumulate on the cathode surface. The sulfate on the cathode surface restricts the capacity of the battery and traps the zinc ions, causing ZHS to form on the cathode. When the ZHS is formed on the cathode, the ZHS can block the manganese oxides from accessing or reacting with the cathode. However, as explained above, when the ZHS is in the electrolyte, the ZHS can help increase the number of protons available for dissolving manganese oxides.

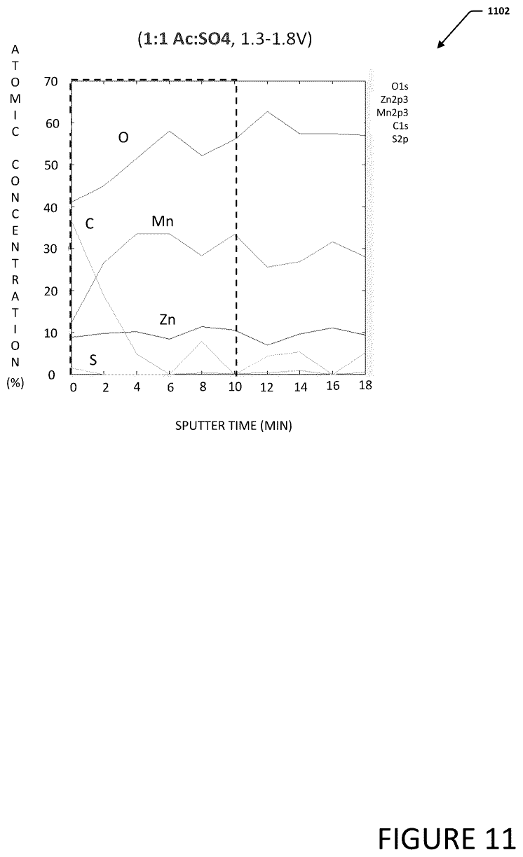

Turning to FIG. 11, FIG. 11 illustrates a graph 1102 showing example non-limiting details related to the species on the cathode after cycling a battery with two buffers (acetate and sulfate) in the electrolyte, in accordance with an embodiment of the present disclosure. As compared to graph 1002, the sulfate that is accumulated on the cathode is less when two buffers are used in the electrolyte as compared to when only one buffer is used in the electrolyte. As explained above, with the two buffers in the electrolyte, the pH of the electrolyte can be within a range that can dissolve at least a portion of the oxidized by products formed when the battery is discharged and help to increase the capacity of the battery. The two buffers can help achieve a desired pH range for the battery during cycling of the battery.

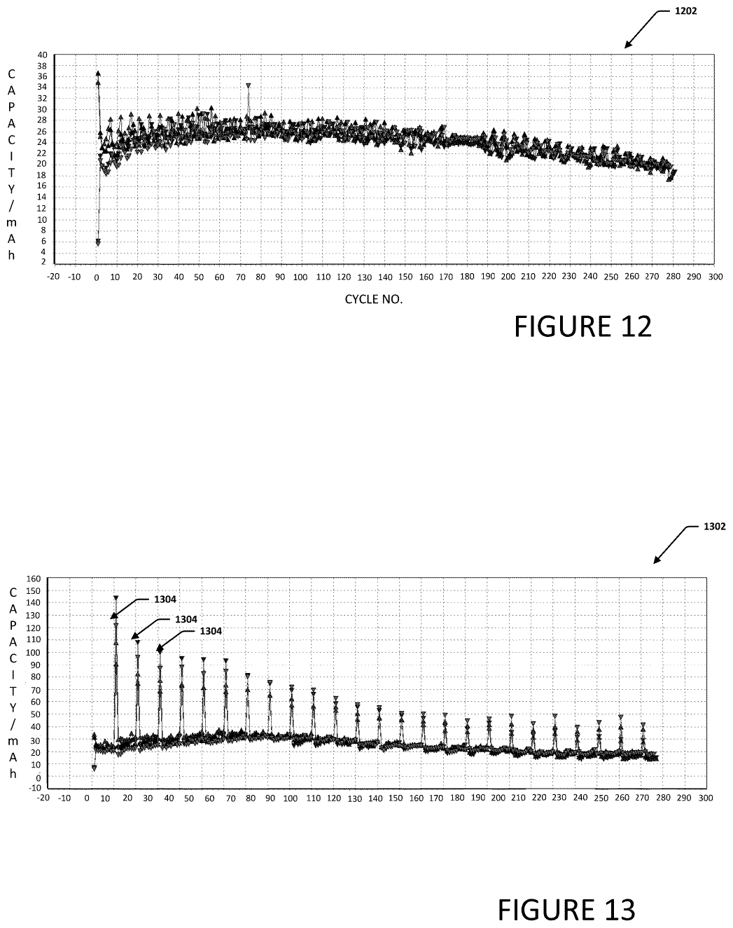

Turning to FIG. 12, FIG. 12 illustrates a graph 1202 showing example non-limiting details of the capacity of a battery as the battery cycles between charging and discharging, in accordance with an embodiment of the present disclosure. As illustrated in graph 1202, as the battery cycles through charging and discharging, the capacity of the battery decreases. The reason the capacity of the battery decreases is because oxides and other by-products created when the battery is discharged become accumulated on the cathode surface. More specifically, in a manganese cathode battery, the oxides and other by-products inhibit and/or block the manganese from deposited on the cathode

Turning to FIG. 13, FIG. 13 illustrates a graph 1302 showing example non-limiting details of the capacity of a battery as the battery cycles between charging and discharging after conditioning the battery, in accordance with an embodiment of the present disclosure. Peaks 1304 represent when electrical conditioning of the battery is performed. Note that for clarity and conciseness, not all the electrical conditioning peaks are labeled. As shown in the graph 1302, when electrical conditioning of the battery is performed, the capacity of the battery is not reduced or is not reduced as much, as contrasted to when electrical condition of the battery is not performed, as illustrated by graph 1202 in FIG. 12.

During the electrical conditioning, a long discharge time (e.g., about 4 or more hours) as compared to the cycle time of the battery can be performed at about 1.4 volts to about 1.8 volts to help dissolve at least a portion of the accumulated material on the cathode back into the electrolyte. The electrical conditioning helps dissolve manganese, manganese oxides, and other material on the cathode so the manganese is free to be deposited on the cathode and the capacity of the battery can be maintained. The electrical conditioning helps to avoid having to provide or add chemicals or modify assembly of the battery. The electrical conditioning can be performed after a predetermined number of cycles (e.g., 10 cycles, 20 cycles, etc.). After the electrical conditioning has been performed, the battery can return to cycling between charging and discharging and the assembly of the battery does not need to be modified and conditioning chemicals do not need to be added to the battery.

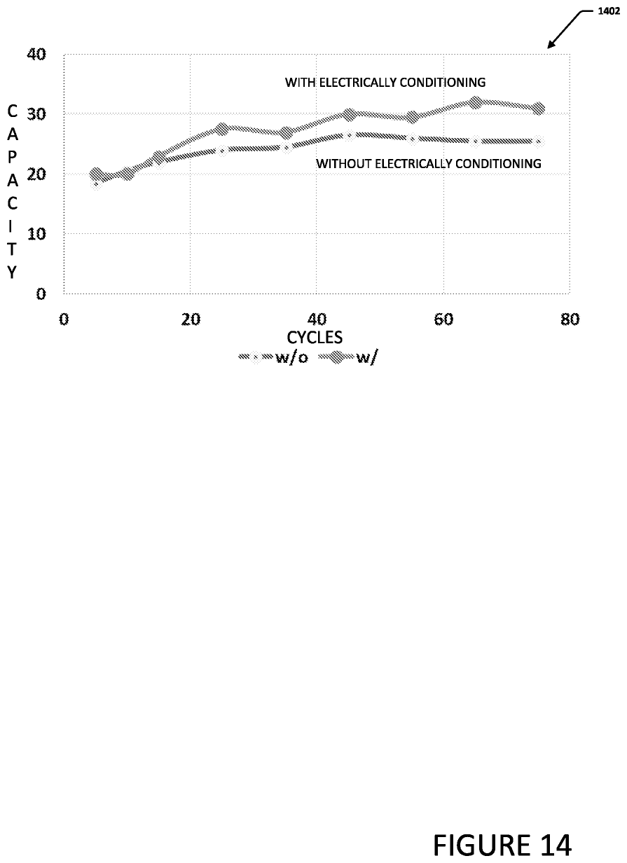

Turning to FIG. 14, FIG. 14 illustrates a graph 1402 showing example non-limiting details comparing electrical conditioning of a battery as compared to not electrically conditioning the battery, in accordance with an embodiment of the present disclosure. As a battery cycles through charging and discharging, oxides and other by-products created when the battery is discharged become accumulated on the cathode surface and the capacity of the battery can decrease. The electrical conditioning helps dissolve at least a portion of the oxides and other by-products and allow the capacity of the battery to be maintained.

In a specific non-limiting example, during cycling of a battery with a manganese cathode, the amount of manganese being deposited on the cathode during recharging of the battery and the purity of the manganese affects the capacity of the battery. During the electrical conditioning of the battery, at least a portion of the oxides and other by-products are dissolved from the cathode to make room on the cathode for the deposition of manganese. Also, the electrical conditioning can help create pure manganese ions to be deposited on the cathode. By removing the oxides and other by-products from the cathode to make room for pure manganese ions, the electrical conditioning of the battery can help to increase the capacity of the battery during cycling of the battery as compared to not electrical conditioning battery during cycling of the battery.

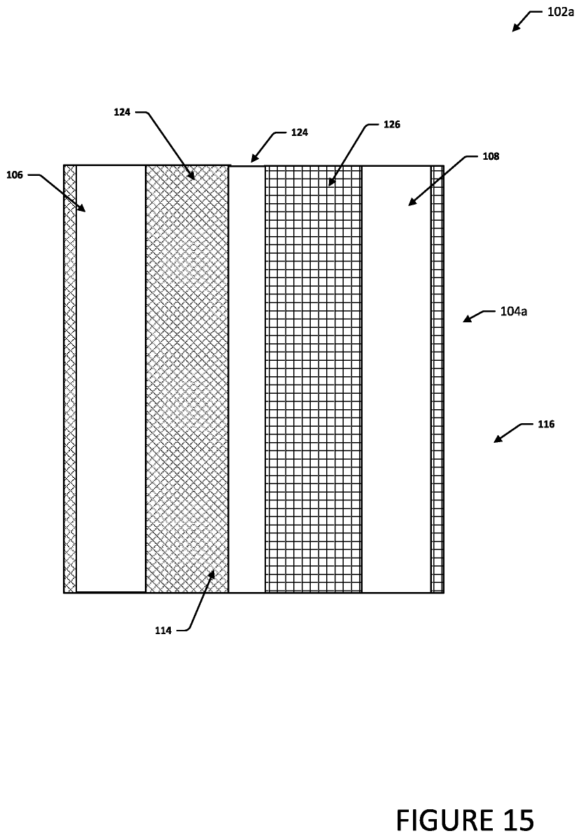

Turning to FIG. 15, FIG. 15 illustrates example non-limiting details of a battery 102a, in accordance with an embodiment of the present disclosure. The battery 102a can include an outer casing 104a, the cathode 106, the anode 108, a first electrolyte 124, a second electrolyte 126, and a separator 128. The outer casing 104a defines an interior space 114 inside the battery 102a. The interior space 114 includes the cathode 106, the anode 108, the first electrolyte 124, the second electrolyte 126, and the separator 128 and helps keep the cathode 106, the anode 108, the first electrolyte 124, the second electrolyte 126, and the separator 128 from being exposed to an outside environment 116. The outside environment 116 is the environment around the battery 102 or the environment outside of the outer casing 104a.

In an example, the first electrolyte 124 can include a cathode compatible buffer and the second electrolyte 126 can include an anode compatible buffer. The first electrolyte 124 and the second electrolyte 126 can control the pH of the battery 120a such that during charging, the pH is acidic and when discharging the pH is alkaline.

In some examples, the separator 128 is a proton exchange membrane that can allow protons to move in the electrolyte but bulky ions in the first electrolyte 124 and the second electrolyte 126 (e.g., manganese ions and zinc ions) are blocked. Sometimes an additive in the electrolyte is beneficial for the cathode but bad for the anode or beneficial for the anode but bad for the cathode. For example, acetate can be beneficial for the manganese cathode but can be harmful to the zinc anode while the sulfate can be beneficial for the zinc anode but can be harmful for the manganese cathode. The separator 128 allows for the first electrolyte 124 that includes a cathode compatible buffer to be controlled independently of the second electrolyte 126 that includes an anode compatible buffer.

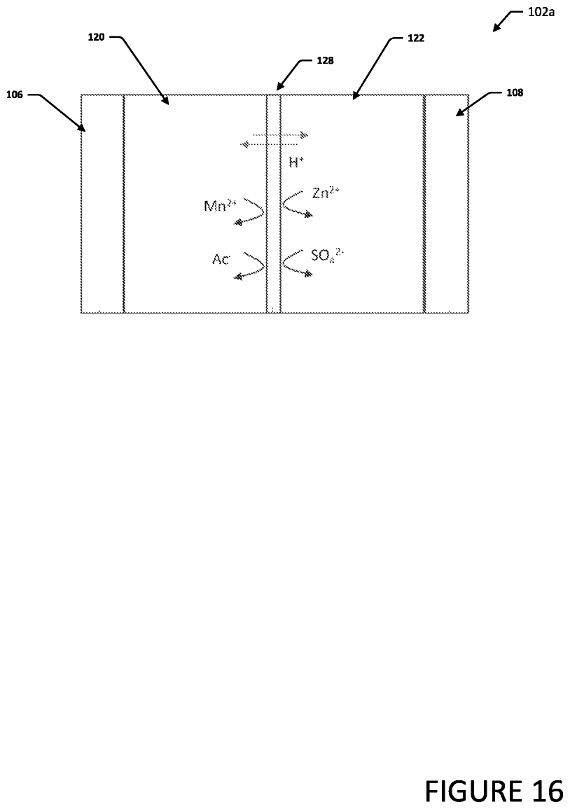

Turning to FIG. 16, FIG. 16 illustrates example non-limiting details of the battery 102a, in accordance with an embodiment of the present disclosure. The battery 102a can include the cathode 106, the anode 108, the first electrolyte 124, the second electrolyte 126, and the separator 128. As illustrated in FIG. 16, the separator 128 is a proton exchange membrane that can allow protons to move in the electrolyte and block bulky ions in the first electrolyte 124 (e.g., manganese ions, acetate ions, etc.) and bulky ions in the second electrolyte 126 (e.g., zinc ions, sulfate ions, etc.) from passing through the separator 128. Additives and ion concentrations in the first electrolyte 124 will not influence the anode 108 and additives and ion concentrations in the second electrolyte 126 will not influence the cathode 106.

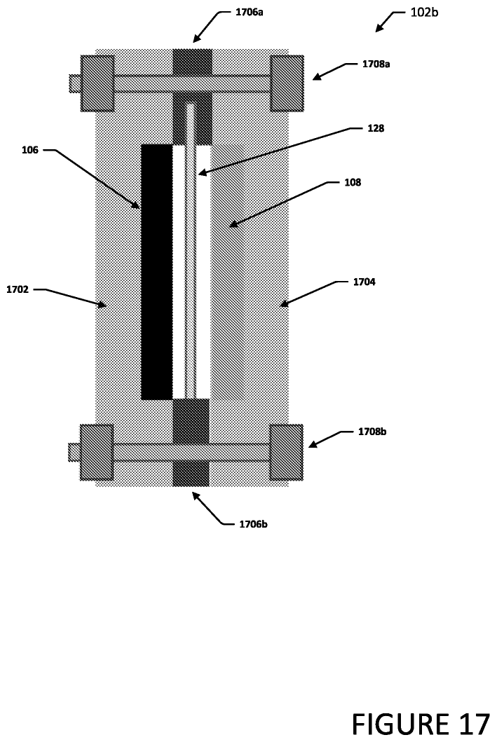

Turning to FIG. 17, FIG. 17 illustrates example non-limiting details of a battery 102b, in accordance with an embodiment of the present disclosure. The battery 102b is functionally similar to the battery 102a illustrated in FIGS. 15 and 16. The battery 102b can include the cathode 106, the anode 108, the first electrolyte 124 (not referenced), the second electrolyte 126 (not referenced), and the separator 128. As illustrated in FIG. 17, the cathode 106 can be in a cathode side housing 1702 and the anode 108 can be in an anode side housing 1704. The separator 128 can be between the cathode side housing 1702 and the anode side housing 1704 and held in place by a sealing gasket 1706a and 1706b or some other means of securing the separator 128 between the cathode side housing 1702 and the anode side housing 1704. The cathode side housing 1702 and the anode side housing 1704 can be secured together using housing securing means 1708a and 1708b. In some examples, the housing securing means 1708a and 1708b are bolt and screw sets, however, other means may be used to secure the cathode side housing 1702 and the anode side housing 1704. In some examples, the cathode side housing 1702 and the anode side housing 1704 form the outer casing 104a illustrated in FIG. 15

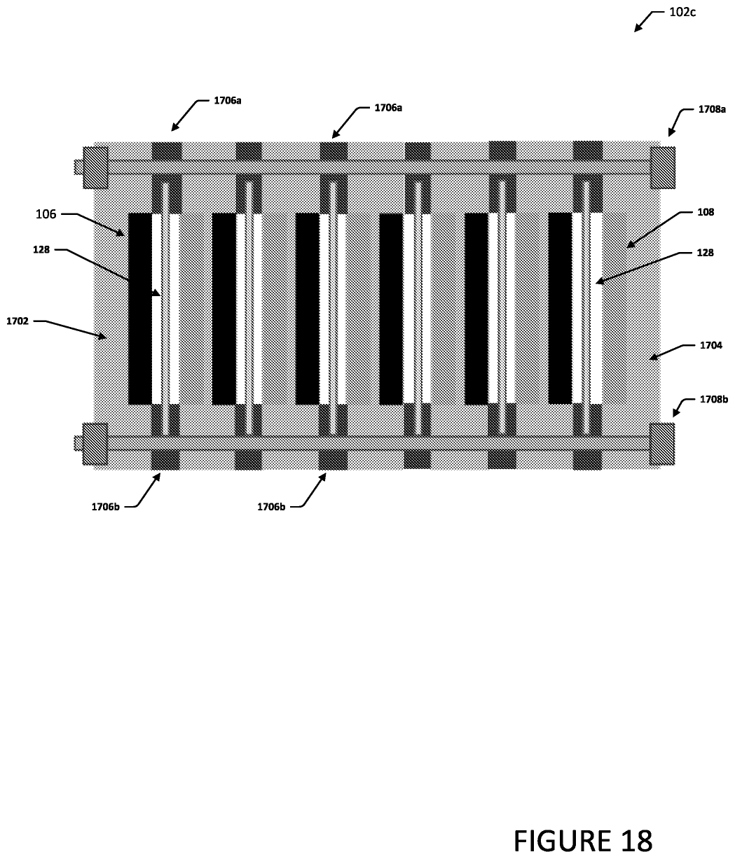

Turning to FIG. 18, FIG. 18 illustrates example non-limiting details of a battery 102c, in accordance with an embodiment of the present disclosure. The battery 102c comprises a plurality of batteries 102b illustrated in FIG. 17. More specifically, the battery 102c can include a plurality of the cathodes 106, a plurality of the anodes 108, the first electrolyte 124 (not referenced), the second electrolyte 126 (not referenced), a plurality of the separators 128 between each of the plurality of the cathodes 106 and the plurality of the anodes 108, a plurality of cathode side housings 1702, a plurality of the anode side housings 1704, and a plurality of the sealing gasket 1706a and 1706b. Note that each element is not referenced in FIG. 18 for clarity. The plurality of cathode side housings 1702 and the plurality of the anode side housings 1704 can be secured together using housing securing means 1708a and 1708b

Substantial flexibility is provided by the battery 102 and 102a-102d in that any suitable arrangements, chronologies, configurations, and timing mechanisms may be provided without departing from the teachings of the present disclosure.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the battery 102 and 102a-102d and its teachings are readily scalable and can accommodate a large number of components, as well as more complicated/sophisticated arrangements and configurations. Accordingly, the examples provided should not limit the scope or inhibit the broad teachings of the battery 102 and 102a-102d and as potentially applied to a myriad of other architectures.

It is also important to note that the operations and/or reactions described herein illustrate only some of the possible correlating scenarios and patterns that may be executed, some of these operations and/or reactions may be deleted or removed where appropriate and without departing from the scope of the present disclosure, or these operations and/or reactions may be modified or changed considerably (e.g., different concentrations, different chemical reactions, etc.) where appropriate and without departing from the scope of the present disclosure. Substantial flexibility is provided in that any suitable arrangements, chronologies, configurations, and timing mechanisms may be provided without departing from the teachings of the present disclosure.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the battery 102 and 102a-102d and their teachings are readily scalable and can accommodate a large number of components, as well as more complicated/sophisticated arrangements and configurations. Accordingly, the examples provided should not limit the scope or inhibit the broad teachings of the battery 102 and 102a-102d and as potentially applied to a myriad of other architectures. Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A zinc battery comprising:
a zinc anode;
a manganese cathode; and
an electrolyte, wherein the electrolyte includes an acetate and a sulfate.

2. The zinc battery of claim 1, wherein the electrolyte has a pH between about 5 pH or below and about 6 pH.

3. The zinc battery of claim 1, wherein the acetate to sulfate ratio is about 1:1.

4. The zinc battery of claim 1, wherein the acetate to sulfate ratio is about 0.3:1 or greater or about 1:0.3 or greater.

5. The zinc battery of claim 1, wherein the electrolyte includes 1 mol of zinc sulfate and 1 mole of zinc acetate per liter and 0.1 moles of manganese sulfate and 0.1 moles of manganese acetate per liter.

6. The zinc battery of claim 1, wherein during recharging of the zinc battery, the sulfate helps to dissolve manganese oxides and create manganese ions.

7. The zinc battery of claim 1, wherein the electrolyte at least partially causes the pH of the electrolyte in an area of the cathode to be alkaline during discharge of the battery and acidic in the area of the cathode during charging of the battery.

8. The zinc battery of claim 1, wherein during charging of the zinc battery between about 1 volt or below to about 2.1 volts or above are applied.

9. The zinc battery of claim 1, wherein during discharge of the zinc battery, the voltage drops from about 2.1 or above to about 1 volt or below.

10. An electrolyte for use in a battery, the electrolyte comprising:
an acetate; and
a sulfate, wherein the acetate and sulfate are in a range of about 0.3 moles or more of acetate to about 1 mole of sulfate or about 1 mole of acetate to about 0.3 moles or more of acetate.

11. The electrolyte of claim 10, wherein the acetate and the sulfate at least partially cause the pH of the electrolyte in an area of a cathode in the battery to be alkaline during discharge of the battery and acidic in an area of a cathode of the battery during charging of the battery.

12. The electrolyte of claim 11, wherein the battery includes a separator and the area of the cathode is half a distance between the separator and the cathode or less.

13. The electrolyte of claim 10, wherein the acetate to sulfate ratio is about 1:1.

14. The electrolyte of claim 10, wherein the electrolyte has a pH between about 5 pH or below and about 6 pH.

15. A sealed rechargeable metal battery comprising,
a zinc anode;
a manganese cathode;
an electrolyte that includes acetate and sulfate, wherein the electrolyte at least partially causes the pH of the electrolyte in an area of the cathode to be alkaline during discharge of the battery and acidic in the area of the cathode during charging of the battery;
a separator; and
an outer casing, wherein the outer casing defines an interior space of the sealed rechargeable metal battery.

16. The sealed rechargeable metal battery of claim 15, wherein the acetate and sulfate are in a range of about 0.3 moles or more of acetate to about 1 mole of sulfate or about 1 mole of acetate to about 0.3 moles or more of acetate.

17. The sealed rechargeable metal battery of claim 15, further comprising:
a battery management system, wherein the battery management system controls the charging and discharging of the battery.

18. The sealed rechargeable metal battery of claim 17, wherein after a predetermined number of charging and discharging cycles, the sealed rechargeable metal battery is electrically reconditioned using a discharge time that is at least twice as long as a cycle time of the battery.

19. The sealed rechargeable metal battery of claim 18, wherein the electrical reconditioning is performed at about 1.4 volts to about 1.8 volts.

20. The sealed rechargeable metal battery of claim 15, wherein the separator is a proton exchange membrane.
